(19) United States
(12) Patent Application Publication
(10) Pub. No.: US 2026/0054645 A1
(43) Pub. Date: Feb. 26, 2026

(54) VEHICLE VIDEO RECORDING DEVICE AND METHOD OF CONTROLLING THE SAME

(71) Applicants: Hyundai Motor Company, Seoul (KR); Kia Corporation, Seoul (KR)

(72) Inventors: Dong Hyuk JEONG, Hwaseong-Si (KR); Kyoung Jun KIM, Hwaseong-Si (KR); Seok Ju YEOM, Hwaseong-Si (KR); Jeong Muk KANG, Hwaseong-Si (KR); Sung Hwan JUN, Hwaseong-Si (KR); Joo Am BAEK, Hwaseong-Si (KR)

(21) Appl. No.: 19/206,248

(22) Filed: May 13, 2025

(30) Foreign Application Priority Data
Aug. 26, 2024 (KR) 10-2024-0114254

(51) Int. Cl. B60R 1/23

(52) U.S. Cl. CPC B60R 1/23; B60R 2300/101; B60R 2300/301

(57) ABSTRACT

An apparatus may comprise a processor and a memory storing at least one instruction that, when executed by the processor communicating with the memory, is configured to cause the apparatus to detect, using a motion sensor, a movement of an external object in a first detection zone monitored by the motion sensor. Based on the detection of the movement, the apparatus may record, using a camera, a video of a surrounding area of a vehicle, wherein the surrounding area may comprise at least a portion of the first detection zone. The apparatus may adjust one or more settings of the motion sensor for the first detection zone based on position information of the vehicle or frequency of detecting the movement of the external object in the first detection zone, and transmit, based on the adjusted one or more settings, a command to the camera to adjust recording behavior.

### CROSS-REFERENCE TO RELATED APPLICATION

The present application claims the benefit of priority to Korean Patent Application No. 10-2024-0114254, filed in the Korean Intellectual Property Office on Aug. 26, 2024, the entire contents of which are incorporated herein by reference for all purposes.

### TECHNICAL FIELD

The present disclosure relates to a vehicle video recording device and a method of controlling the vehicle video recording device.

### BACKGROUND

The matters described in this Background section are only for enhancement of understanding of the background of the disclosure, and should not be taken as acknowledgment that they correspond to prior art already known to those skilled in the art.

A vehicle video recording device is, for example, a device of recording a video on a traveling or parked state of a vehicle.

The vehicle video recording device may be referred to as a traveling video recording device as the device is mainly aimed to acquire a video on an accident during traveling and the like.

To acquire a video, the vehicle video recording device may comprise a controller, a memory for storing a video, and a camera for imaging a video.

The vehicle video recording device may store a video of a surrounding of a vehicle during traveling along with vehicle traveling data at the time, and record a video in accordance with a pre-input setting when a set event occurrence is sensed even in a parked state.

The vehicle video recording device (e.g., black box), may be mounted externally. Alternatively, the vehicle video recording device may be provided as a built-in device (e.g., embedded in a vehicle before the delivery of the vehicle).

Such a built-in camera may be more advantageous than an external one in that the built-in camera may access to traveling data of a host vehicle and may be connected to other controllers, and therefore use of the built-in camera may gradually increase.

The vehicle video recording device may implement regular recording and event recording during traveling or in a parked state, and may allow system setting and stored video checking, interworking with audio video navigation (AVN).

The vehicle video recording device may be capable to allow long time operation of parking recording with low power due to a limitation of battery capacity.

### SUMMARY

According to the present disclosure, an apparatus may comprise, a processor, and a memory storing at least one instruction that, when executed by the processor communicating with the memory, is configured to cause the apparatus to, detect, using a motion sensor, a movement of an external object in a first detection zone monitored by the motion sensor, based on the detection of the movement, record, using a camera, a video of a surrounding area of a vehicle, wherein the surrounding area may comprise at least a portion of the first detection zone, and adjust one or more settings, of the motion sensor, for the first detection zone based on at least one of position information of the vehicle or frequency of detecting the movement of the external object in the first detection zone, and transmit, based on the adjusted one or more settings, a command to the camera to adjust recording behavior.

The apparatus, wherein the position information of the vehicle may comprise navigation information of the vehicle.

The apparatus, wherein the at least one instruction, when executed by the processor communicating with the memory, is configured to cause the apparatus to select one of a plurality of sensitivity levels based on at least one of the position information or the frequency of detecting the movement of the external object in the first detection zone.

The apparatus, wherein the plurality of sensitivity levels are set by at least one of, a false sensing parameter associated with a false sensing area, a time parameter associated with a set time, or a sensing distance parameter of the first detection zone.

The apparatus, wherein the at least one instruction, when executed by the processor communicating with the memory, is configured to cause the apparatus to adjust the one or more settings periodically based on the frequency of detecting the movement of the external object in the first detection zone.

The apparatus, wherein the at least one instruction, when executed by the processor communicating with the memory, is configured to cause the apparatus to, determine that sensing performance of the motion sensor is degraded based on a surrounding environment of the vehicle, and adjust, based on the determination, the one or more settings to extend the first detection zone.

The apparatus, wherein the at least one instruction, when executed by the processor communicating with the memory, is configured to cause the apparatus to, determine that an external object is predicted to enter into the first detection zone from a second zone within a set time, and transmit, based on the determination, a command to the camera to adjust the recording behavior by causing at least one of an adjustment of the first detection zone or an adjustment of a recording time associated with the first detection zone.

The apparatus, wherein the one or more settings are adjusted to exclude a false sensing prevention area of the motion sensor.

According to the present disclosure, a method performed by an apparatus of a vehicle, the method may comprise, starting a parking mode of a video recorder, detecting, using a motion sensor, a movement of an external object in a surrounding area of the vehicle, wherein the surrounding area may comprise at least a portion of a first detection zone monitored by the motion sensor, adjusting one or more settings, of the motion sensor, for the first detection zone based on at least one of position information of the vehicle or frequency of detecting a movement of the external object in the first detection zone, and transmitting, based on the adjusted one or more settings, a command to the video recorder to adjust recording behavior for recording the surrounding area of the vehicle.

The method, wherein the starting the parking mode may comprise, turning the motion sensor on, switching the video recorder into a sleep mode or a turned-off state, and switching a control circuit of the apparatus into a sleep mode or a turned-off state.

The method, wherein the position information of the vehicle may comprise navigation information of the vehicle.

The method, wherein the adjusting the one or more settings may comprise selecting one of a plurality of sensitivity levels based on at least one of the position information or the frequency of detecting the movement of the external object in the first detection zone.

The method, wherein the plurality of sensitivity levels are set by at least one of, a false sensing parameter associated with a false sensing area, a time parameter associated with a set time, or a sensing distance parameter of the first detection zone.

The method, wherein the adjusting the one or more settings may comprise adjusting the one or more settings periodically based on the frequency of detecting the movement of the external object in the first detection zone.

The method, wherein the adjusting the one or more settings may comprise, determining that sensing performance of the motion sensor is degraded based on a surrounding environment of the vehicle, and adjusting, based on the determining, the one or more settings to extend the first detection zone.

The method may further comprise, determining that the external object is predicted to enter into the first detection zone from a second zone within a set time.

The method, wherein the one or more settings are adjusted to exclude a false sensing prevention area of the motion sensor.

According to the present disclosure, an apparatus of a vehicle, the apparatus may comprise, a processor, and a memory storing at least one instruction that, when executed by the processor communicating with the memory, is configured to cause the apparatus to, detect, using a motion sensor, at least one detected characteristic of a surrounding area of the vehicle, adjust, based on the at least one detected characteristic, a setting of the motion sensor, wherein the adjusted setting is associated with at least one of an adjusted detection zone of the motion sensor or an adjusted recording condition of the motion sensor, control, based on the adjusted setting, the motion sensor to detect motions within at least a portion of the surrounding area of the vehicle, and perform, based on the detected motions, video recording of the at least the portion of the surrounding area of the vehicle.

The apparatus, wherein the at least one detected characteristic of the surrounding area of the vehicle may comprise at least one of, at least one physical object detected in the surrounding area of the vehicle, a location of the vehicle determined based on navigation information of the vehicle, or frequency of detecting movement of an external object in the at least the portion of the surrounding area of the vehicle.

The apparatus, wherein the setting of the motion sensor is adjusted by modifying at least one of a sensing range, a sensitivity level, or a false sensing prevention parameter of the motion sensor, and wherein the sensing range may comprise the at least the portion of the surrounding area of the vehicle.

Effects that the present disclosure is to achieve are not limited to the effects described above, and other effects that have not been described will be clearly understood by those having ordinary knowledge in the technical field to which the present disclosure belongs, from the description below.

### BRIEF DESCRIPTION OF THE DRAWINGS

FIG. 1 shows an example of a vehicle video recording device according to an example of the present disclosure and a configuration of a vehicle including thereof.

FIG. 2 shows an example of dividing sensor sensing areas according to an example of the present disclosure.

FIG. 3 shows an example of a shape of a first area of a motion sensor and varying of a distance sensing parameter according to an example of the present disclosure.

FIG. 4 shows an example of a case of using navigation information among varying criteria of a first area of a motion sensor of a vehicle video recording device according to an example of the present disclosure.

FIG. 5 shows an example of a case of using information on a number of times of sensing an external object among varying criteria of a first area of a motion sensor of a vehicle video recording device according to an example of the present disclosure.

FIG. 6 shows an example of a case of using information on a surrounding environment of a vehicle among varying criteria of a first area of a motion sensor of a vehicle video recording device according to an example of the present disclosure.

FIG. 7 is an exemplary flowchart showing how navigation information is used as criteria for dynamically adjusting a first area of a motion sensor of a vehicle video recording device according to an example of the present disclosure.

FIG. 8 is an exemplary flowchart showing how information on a number of times of sensing an external object is used as criteria for dynamically adjusting a first area of a motion sensor of a vehicle video recording device according to an example of the present disclosure.

### DETAILED DESCRIPTION

Because the present disclosure may be modified in various ways and may have various examples of the present disclosure, specific examples will be illustrated and described in the drawings. However, this is not intended to limit the present disclosure to specific examples, and it should be understood that the present disclosure includes all modifications, equivalents, and replacements included on the idea and technical scope of the present disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Terms including ordinals such as “first”, “second”, and the like may be used to describe various elements, but the elements are not limited by the terms. The terms are used only as name meaning for distinguishing one element from another element, and sequential meaning between the elements are understood not from the name but from the context of the description.

The term “and/or” is used to include any combination of a plurality of items to be included. For example, “A and/or B” includes all three cases such as “A”, “B”, and “A and B”. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When it is mentioned that an element is “connected” or “linked” to another element, it should be understood that the element may be directly connected or linked to another element, but another element may exist in between.

The terminology used herein is for describing specific exemplary examples only and is not intended to be limiting of the present disclosure. Singular expressions include plural expressions, unless the context clearly indicates otherwise. In the present application, it should be understood that the term “include” or “have” indicates that a feature, a number, a step, an operation, a component, a part, or a combination thereof described in the specification exists, but does not exclude the possibility of existence or addition of one or more other features, numbers, steps, operations, components, parts, or combinations thereof in advance.

Unless otherwise defined, all terms used herein, including technical or scientific terms, include the same meaning as that generally understood by those skilled in the art. It will be understood that terms, such as those defined in commonly used dictionaries, should be interpreted as including a meaning which is consistent with their meaning in the context of the relevant art and will not be interpreted in an idealized or overly formal sense unless so defined herein.

Furthermore, the term “unit”, “control unit”, “control device”, or “controller” is a term widely used for naming a controller that commands a specific function, and does not mean a generic function unit. For example, a control unit by these names may include a communication device that communicates with another controller or sensor to control a corresponding function, a computer-readable recording medium that stores an operating system or a logic command, input/output information, and the like, and one or more processors that perform judgement, calculation, determination, and the like necessary for controlling the corresponding function.

Meanwhile, the processor may include a semiconductor integrated circuit and/or electronic systems that perform at least one or more of comparison, judgement, calculation, and determination to achieve a programmed function. For example, the processor may be one of a computer, a microprocessor, a CPU, an ASIC, and an electronic circuit (circuitry, logic circuits), or a combination thereof.

The processor may be electrically connected to the memory, and the processor may retrieve and record data from the memory. The memory and the processor may be integrated or may be physically separated.

Hereinafter, examples of the present disclosure will be described in detail with reference to the accompanying drawings.

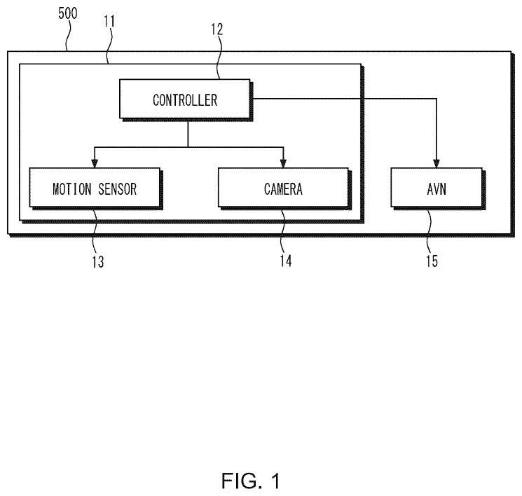

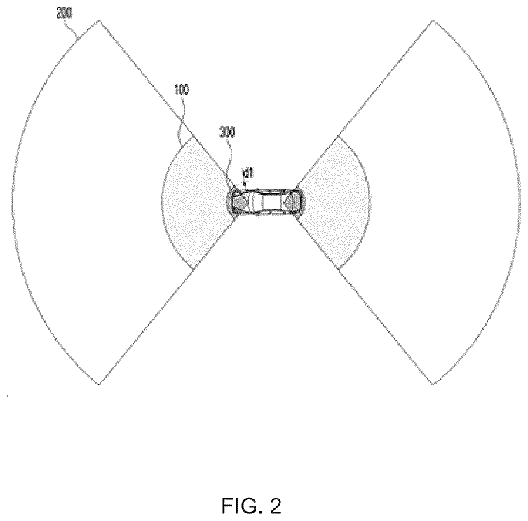

FIG. 1 shows an example of a vehicle video recording device according to an example of the present disclosure and a configuration of a vehicle including thereof.

Surely, each element illustrated in FIG. 1 illustrates only an element related to examples, and more elements may be included in a vehicle (500) and a vehicle video recording device (11). For instance, additional components may include GPS modules, accelerometers, microphones, or night vision cameras, etc. In particular, the vehicle video recording device (11) of the present example is a built-in device, but this is not limited thereto.

With reference to FIG. 1, the vehicle video recording device (11) according to an example of the present disclosure includes a motion sensor (13) that senses movement of an external object in the vicinity of the vehicle (500), a camera (14) that records a video footage outside of the vehicle (500), and a controller (12) that commands the camera (14) to start recording the video according to sensing results. In addition, there is an AVN (15) connected to the controller (12) via communication.

The motion sensor (13) that senses movement of an external object in the vicinity of the vehicle (500) may include, for example, at least one of a radar, a lidar, ultrasonic sensors, an infrared sensor, or a stereo camera, etc., and may sense a distance between the external object moving at a front/rear/left/right side of the vehicle (500) and the vehicle. The motion sensor (13) may be integrated with a camera (14) module, or separately mounted inside or outside the vehicle (500). The motion sensor (13) may be applied only to the front side, may to the front/rear side, or may to the front/rear/left/right side. The types of sensors that may be included in the motion sensor (13) are not limited. Any sensor capable of detecting external movement may may of an external object of the vehicle (500) may be used. In addition, the motion sensor (13) may be provided exclusively for the vehicle video recording device (11), but a radar sensor used in an advanced driver assistance system (ADAS), lane departure warning (LDW), or collision avoidance system, etc., installed in the vehicle (500) may also be used.

The camera (14) includes a front camera and a rear camera in the present example, but additional cameras, such as side-view cameras or interior monitoring cameras, may also be included. The front camera is installed to capture a video footage of the front area of the vehicle (500), and the rear camera is installed to capture a video footage of the rear area of the vehicle (500).

For example, the front camera may be installed on a windshield in the vicinity of a rearview mirror in a vehicle cabin of the vehicle (500), and the rear camera may be installed on a rear window or a rear bumper of the vehicle cabin of the vehicle (500).

For example, the front camera and the rear camera may support various resolutions such as HD, FHD, and Quad HD, or even higher resolutions such as 4K, depending on the model. The front camera and the rear camera do not necessarily have the same image quality, and a camera for an ADAS system or a night vision system of the vehicle (500) may be used.

In addition, the camera (14) preferably has an aperture value of F2.0 or lower, and preferably has an aperture value of F1.6 or lower. As the aperture value decreases, more light is captured, and thus video recording may may appear brighter and clearer. In addition, as an image tuning technology is applied, noise and light loss are minimized, and thus clear recording may be implemented even in a dark environment. For example, advanced image processing technologies such as high dynamic range (HDR) or digital noise reduction (DNR) may be applied to reduce or minimize noise and light loss, allowing for superior recording quality even in low-light or nighttime conditions.

The controller (12) may implement continuous recording during traveling and event-based recording in a parked state by controlling a configuration of the motion sensor (13), the camera (14), and other related components. It may transmit a command to the camera (14) to prepare for and start recording according to motion detection signal (e.g., a sensing signal from the motion sensor (13)). In addition, the controller (12) may allow users to set specific recording parameters, such as motion sensitivity or recording duration, via a user interface (e.g., including a user menu) on the AVN (15).

The AVN (15) is connected via communication by a vehicle controller or directly to the controller (12). A display screen of the AVN (15) may function as a user-friendly interface for selecting various setting parameters (e.g., parameters for setting motion sensitivity levels, video storage preferences, or reviewing recorded footage, etc.) of the vehicle video recording device (11) by a user.

FIG. 2 shows an example of dividing sensor sensing areas according to an example of the present disclosure.

With reference to FIG. 2, a first area (100) may be a range based on a distance from the center of the camera (14) to the front side of the vehicle (500) and a distance extending laterally between the left and right of the vehicle (500) in a camera capturing direction. For example, the sensing area may be circular, rectangular, or dynamically adjusted based on environmental conditions, etc. For example, a distance standard may be set as a radius, and this may be a distance sensing parameter based on the distance information. Examples exemplify a front side and a rear side, but may also be applied to a left side and a right side. In addition, the first area (100) may be set such that a false sensing prevention area (300) sensed at a specific distance (d) or less is excluded to prevent erroneous motion detection (e.g., false sensing of the motion sensor (13)), and this may be a false sensing distance parameter. For example, a false sensing area may include reflections from static objects such as parked vehicles, fences, or walls, etc. In addition, a set time is based on estimated duration for an external object to move from a second area (200) to the first area (100), and this may be a time parameter. Each parameter may be set or customized by a user based on, for example, preference or environmental conditions.

The second area (200) may be an area determined by excluding the first area (100) and a false sensing prevention area (300) from the entire range area defined for sensing by the motion sensor (13). For example, the second area (200) may extends beyond the first area (100) and has a greater sensing distance than the first area (100). For instance, the second area may be used to monitor approaching objects before they enter the primary detection zone. For example, currently, lidar sensors may estimate a speed, a direction, and classification (e.g., pedestrian, bicycle, vehicle, etc.) of an external object up to 30 meters. The sensing distance parameter of the first area (100), which defines when recording should begin, may be configured between 10 to 15 meters. However, depending on the vehicle's surroundings and motion detection sensitivity, this value may be further adjusted. It is obvious for those skilled in the art that this is only an example and may be used in various ways in other specific forms.

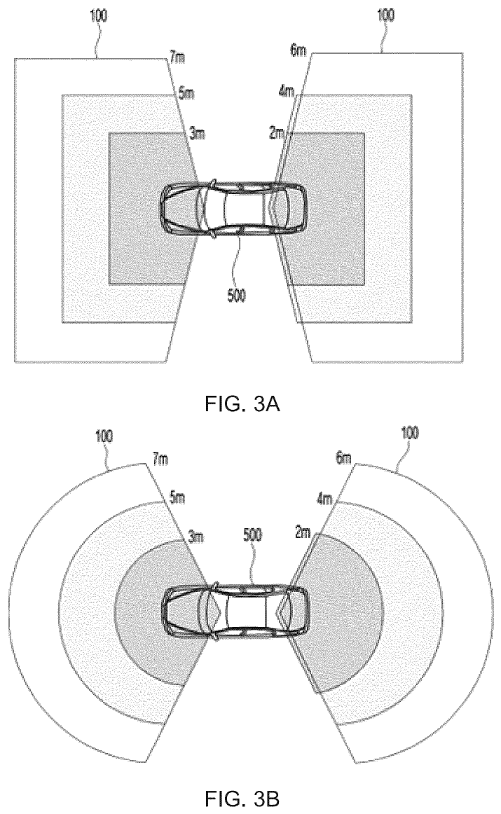

FIG. 3A and FIG. 3B illustrate examples of variations in the first area of the motion sensor and its corresponding distance sensing parameter adjustments according to an example of the present disclosure.

FIG. 3A illustrates a time point when the sensing range of the first area (100) of the motion sensor (13) is in a pentagon shape on front/rear sides of the vehicle, and distance sensing parameters related to the first area (100) are applied at 3 m, 5 m, and 7 m. FIG. 3B illustrates a time point when the sensing range of the first area (100) of the motion sensor (13) is in a fan shape on front/rear sides, and distance sensing parameters related to the first area are applied at 3 m, 5 m, and 7 m. Both of FIG. 3A and FIG. 3B exemplify front/rear detection zones, but this may also be applied to the left/right side. For example, left/right detection zones may be beneficial for enhancing safety in highway merging scenarios.

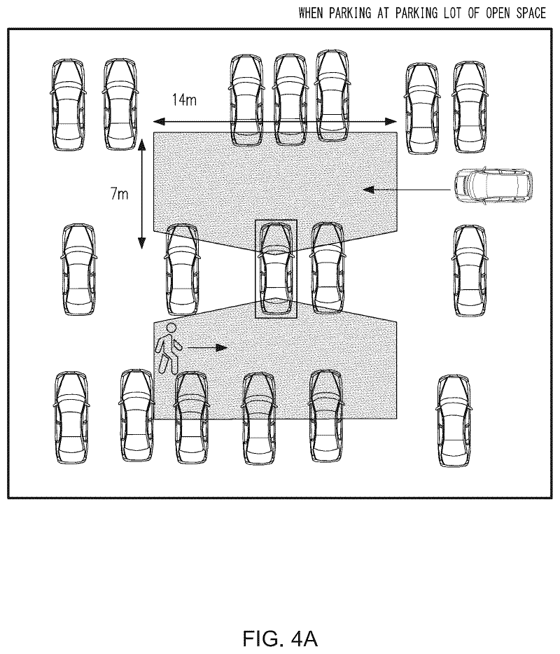

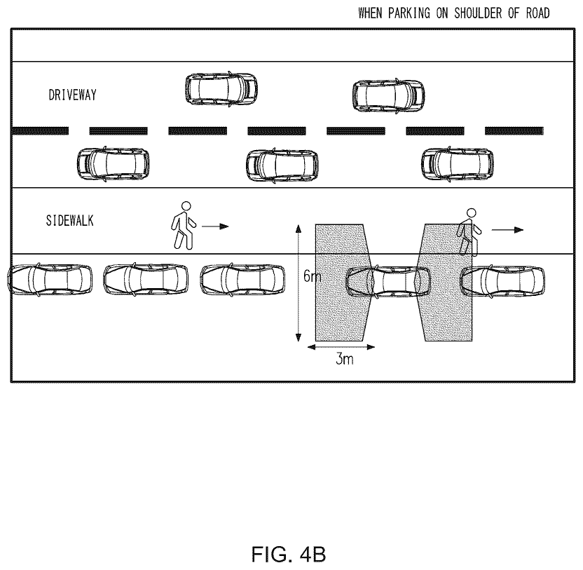

FIG. 4A and FIG. 4B illustrate an example of a case of using navigation information among first area varying criteria of the motion sensor of the vehicle video recording device according to an example of the present disclosure.

With reference to FIG. 4, FIG. 4A is an example illustrating a position at which there is no frequent movement of an external object in the first area (100) of the motion sensor (13) within a parking area such as an open-space parking lot, underground garage, or designated private parking area, etc. This position may be identified may using navigation information. For example, GPS-based mapping data or geofencing may be used to recognize that the vehicle is in a low-traffic parking area. When the position is identified according to the navigation information as described above, a range of the first area (100) may be dynamically adjusted based on the position, and motion sensing recording is performed based on the adjusted range of the first area (100).

When the range of the first area (100) is set or adjusted based on the position, sensitivity levels may be set or adjusted by comparing a set threshold value against a detection frequency of the motion sensor (13) at that position. The sensitivity is set to a plurality of levels. For example, in a three level sensitivity system, the level 1 has the smallest range of the first area (e.g., areas with high motion activity to reduce or minimize unnecessary recordings), and the level 3 has the widest range of the first area (e.g., low-traffic areas where even minor movement should be detected). The level 2 has an intermediate range between the level 1 and the level 3 (e.g., a moderate range suitable for mixed environments).

Setting the sensitivity level may include setting the level to the level 1 in a case where a frequency of sensing of an external object exceeds a first preset threshold value, setting the level to the level 3 in a case where a frequency of sensing of an external object falls below a second preset threshold value, and setting the level to the level 2 in a case where a frequency of sensing of an external object falls between the second preset threshold value and first preset threshold value. In addition, when setting the sensitivity level, other factors such as may a false sensing parameter (to filter out static objects like trees, parked cars, or building reflections, etc.) related to the false sensing area (300) and a time parameter (to define how long an object must remain in the detection area before recording begins) related to a set time may also be included, in addition to a sensing parameter related to the first area (100).

When there is no frequent movement of an external object in the first area (100) such as in an open space parking lot, the frequency of motion detection (e.g., sensing of the external object) is lower than the second preset threshold value. As a result, the sensitivity level may be set to the level 3 which has the widest range of the first area (100) of the motion sensor, ensuring that any motion, even at a greater distance, may be recorded. FIG. 4A illustrates an example where the distance sensing parameter is set to 7 m. This configuration may ensure that motion in a wider area may be captured when fewer external factors interfere.

FIG. 4B shows an example where vehicles are parked near a driveway (e.g., a roadside shoulder, a commercial parking lot adjacent to pedestrian walkways, or a rest area, etc.). In such area, movement of an external object that does not pose an accident risk (e.g., passing pedestrians, cyclists, or other vehicles, etc.) can be frequently detected. This position may be may recognized by using navigation information, which helps determine that the vehicle is in a high-motion area and should limit its sensing range accordingly. For example, in such high-traffic environments, excessive false detections could cause unnecessary recordings and excessive power consumption. As the shoulder described above, when movement of an external object is frequently sensed, and thus frequency of sensing of the external object exceeds the first preset threshold value, the sensitivity level may be set or switched to the level 1, reducing the detection range of the first area (100) of the motion sensor (13) to prevent unnecessary recordings. FIG. 4(b) illustrates an example where the distance sensing parameter is set to 3 m. This may ensure that only objects within close proximity—such as potential threats or nearby approaching vehicles—are captured, improving recording efficiency.

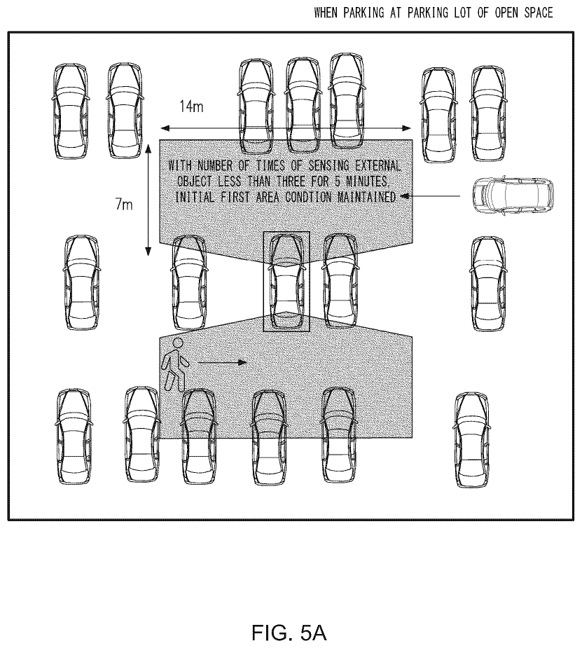

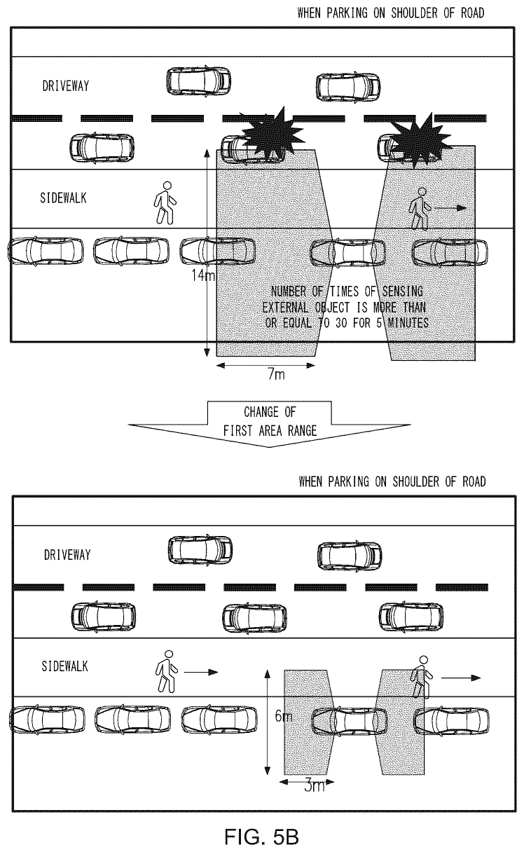

FIG. 5A and FIG. 5B illustrate an example of a case of using information on the number of times of sensing an external object among first area varying criteria of the motion sensor of the vehicle video recording device according to an example of the present disclosure.

FIG. 5A shows an example where there is no frequent movement of an external object in the first area (100) of the motion sensor within a parking location (e.g., a secured lot, a private driveway, or a low-traffic underground garage, etc.). In this case, an external object is sensed at a frequency equal to or lower than the set number of times during a set time after a vehicle has been parked based on the initially set range of the first area (100). Since minimal motion is detected, the initially set range of the first area (100) is maintained. The initially set range of the first area (100) (e.g., initial sensing range), the time (e.g., detection time window), the number of times (e.g., allowed detection frequency), and the like may adjusted by a user. For example, in a case where the sensitivity level related to the range of the first area (100) is divided into three levels, the initial range of the first area (100) (e.g., default initial detection range) may be set to the widest level 3, which provides the widest coverage. FIG. 5A exemplifies a case where the set distance sensing parameter of the first area (100) is 7 m, the set time (e.g., evaluation time window) is 5 minutes, and the set number of times (e.g., allowed detection frequency) is 3 occurrences. If the detected motion remains below 3 times within 5 minute windows, then the default initial detection range of the level 3 stays, ensuring a wider detection radius for low-traffic environments.

FIG. 5B shows an example where vehicles are parked on a high-traffic location, such as a shoulder near a driveway, a curbside spot in a commercial district, or a parking lane adjacent to pedestrian walkways, etc. In these environment, the motion sensor frequently detects moving objects that are not associated with a potential accident risk (e.g., passing pedestrians, bicycles, or vehicles traveling on the main roadway, etc.). If the number of detected objects equals or exceeds the set number of times for a set time after a vehicle has been parked based on the initially set range of the first area (100), then the initially set range of the first area (100) is automatically changed to be narrower to prevent excessive, unnecessary recordings. This adjustment helps reduce false positives and power consumption, adapting to dynamic environments. The initially set range of the first area (100), the time window, the number of times, and the like may adjusted by a user. For example, in a case where the sensitivity level related to the range of the first area (100) is divided into three levels, the initial range of the first area (100) may be set to the widest level 3. FIG. 5B exemplifies a case where the set distance sensing parameter of the first area (100) is initially set to 7 m, the set time window for monitoring is 5 minutes, and the set number of times (e.g., detection threshold) is 30 occurrences. If movement is sensed 30 or more times within 5 minutes, then the sensitivity level is switched to the level 1 that has the narrowest range of the first area (100), ensuring only nearby objects are recorded.

In addition, even after the first area (100) is adjusted, the detection conditions may be continuously evaluated at predefined intervals. may The detection frequency is reassessed at each set time, allowing the first area (100) to be further adjusted based on real-time conditions. For example, if movement significantly decreases after an initial period of high activity, the system may gradually expand the detection area again.

Setting the sensitivity level may involve the following adjustments: Level 1 (narrowest range) is set if the motion detection frequency surpasses a predefined third threshold value, Level 3 (widest range) is set if the motion detection frequency falls below a predefined fourth threshold value,, and Level 2 (moderate range) is set if the detection frequency falls between the third and fourth thresholds. This adaptive sensitivity may ensure that the system optimally balances coverage and efficiency based on environmental conditions.. In addition, when setting the sensitivity level, may factors such as false sensing parameters (e.g., filtering out reflections from static objects like parked cars, fences, or signage, etc.) and time-based parameters (e.g., adjusting detection behavior based on motion persistence over time) may be included to enhance detection accuracy.

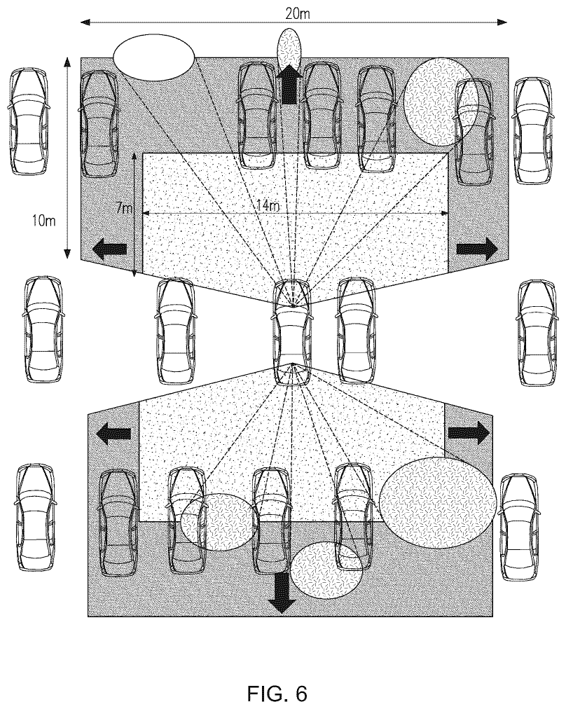

FIG. 6 shows an example of a case of using information on environment of a surrounding of a vehicle among the first area varying criteria of the motion sensor of the vehicle video recording device according to an example of the present disclosure.

With reference to FIG. 6, when a vehicle is parked with many surrounding vehicles (e.g., such as a densely packed parking lot, a multi-level garage, or a congested roadside space, etc.), performance of the motion sensor may be compromised due to occlusions. In such scenarios, external objects, such as pedestrians or moving vehicles, may be frequently obstructed from view, reducing the effectiveness of standard motion sensing. To compensate for this, the motion sensor's detection range and sensitivity may be dynamically adjusted to detect external objects moving between parked vehicles by extending a range (e.g., sensing distance) and adjusting intensity of the motion sensor. This method may be applied through a pre-configured setting that estimate the density of the surrounding vehicles using various sensing technologies, such as an ultrasonic sensor or a traveling radar, or image recognitions before the vehicle is parked. For example, after parking, the method may further refine detection settings by analyzing may a radar reflection wave to detect stationary objects. In a case where there are surrounding vehicles, the motion sensor may more accurately detect a moving object between vehicles by widening a range of the first area (100) of the motion sensor. For example, if the default sensing distance is initially set to 7 m, it may be extended to 10 m to improve detection capabilities in areas where parked vehicles create visual obstructions.

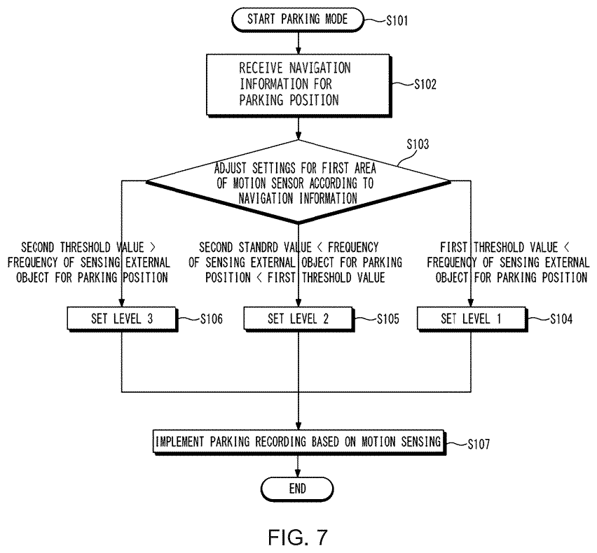

FIG. 7 is an exemplary flowchart showing how navigation information is used as a criteria for dynamically adjusting the first area of the motion sensor of the vehicle video recording device according to an example of the present disclosure.

With reference to FIG. 7, when a parking mode starts (S101), the motion sensor is turned ON, and the camera and the controller are switched to a sleep mode or turned OFF (e.g., power saving). For example, the controller (12) of the vehicle video recording device may receive navigation information and process the navigation information to determine a parking position based on frequency of sensing of an external object (S102). This information may help determine whether the vehicle is in a low-traffic or high-traffic parking area. For example, navigation information may comprise GPS coordinates, map data (e.g., parking lot, roadside, or high-traffic area), road type classifications (e.g., residential street, highway, or commercial zone), and traffic patterns. This data may help the controller adjust the motion sensor's detection range based on the parking environment. The first area (100) of the motion sensor is set or adjusted according to the received navigation information (S103). The first area (100) may be a sensing range of the motion sensor, which may be a recording standard. Setting the first area (100) includes setting the level to the level 1 that has a narrow sensing range (e.g., 3 m) in a case of a position at which an external object is sensed more than the set standard (first threshold value) (S104), setting the level to the level 3 that has a wide sensing range (e.g., 7 m) in a case of a position at which an external object is sensed less than the set standard (second threshold value) (S106), and setting the level to the level 2 in a case where frequency of sensing of an external object is set at an intermediate level between the level 1 and the level 3 (between second threshold value and first threshold value) (S105). For example, a narrow sensing range may be set to 3 m, and a wide sensing range may be set to 7 m. These values are merely an example, and may be adjusted by a user or system algorithms as needed to suite specific environment. When an appropriate level based on the position (e.g., level 1, level 2, or level 3) is set, parking recording based on motion sensing is activated or performed (S107). The parking recording is triggered when the external object is detected within the first area (100) or when the external object is predicted to enter into the first area (100) from the second area (200) within a set time. This predictive capability may help capture relevant motion events even before they occur in the immediate detection zone.

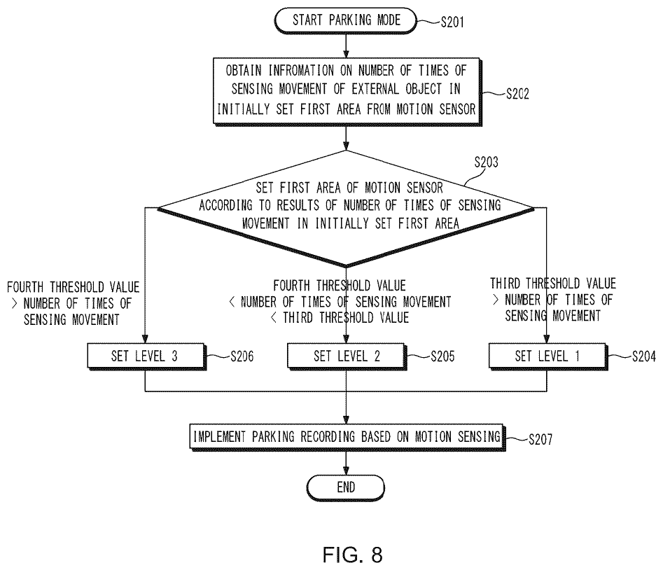

FIG. 8 is an exemplary flowchart showing how information on a number of times of the external object is used as criteria for dynamically adjusting the motion sensor of the vehicle video recording device according to an example of the present disclosure.

With reference to FIG. 8, when the parking mode starts (S201), the motion sensor is turned ON, and the camera and the controller are switched to a sleep mode or turned OFF to conserve energy. In addition, information on the number of times of sensing an external object is determined in the initially set first area (100) from the motion sensor (S202). At this time, the initial standard range of the first area (100) may be set to a relatively wide range (e.g., level 3) to ensure comprehensive initial coverage. For example, the distance sensing parameter may be set to 7 m, which may be suitable for capturing movements across a broad area, such as in open parking lots or low-traffic zones. Once an initial assessment is made, the first area (100) of the motion sensor is adjusted according to the information on a number of times of movement of an external object (S203). may For example, the first area (100) is a sensing range of the motion sensor. Setting the first area (100) includes: setting the level to the level 1 that has a narrow sensing range when an external object is sensed in a number of times equal to or more than the set number of times (third threshold value) for a set time in the initially set first area (100) (S204) (e.g., reducing false alarms in high-traffic areas, such as near busy streets or shopping mall entrances), setting the level to the level 3 that has a wide sensing range when an external object is sensed in a number of times equal to or less than the set number of times (fourth threshold value) within a set time in the initially set first area (100) (S206) (e.g., increased motion sensitivity in low-traffic environments, such as private driveways or secluded parking areas), and setting the level to the level 2 when an external object is sensed in a range of a set number of times (between fourth threshold value and third threshold value) for a set time in the initially set first area (100) (e.g., balancing sensitivity and efficiency, making it suitable for mixed environments where occasional motion occurs) (S205). The set number of times serving as a standard of setting a level includes implementing setting by a user. For example, t he user may manually configure threshold values, or the system may adjust them dynamically based on historical detection patterns. In addition, even after the level is set and the first area (100) has been changed once, motion activity is continuously monitored at regular intervals. For example, the standard time is set, the number of times of sensing an external object is determined at each set time, and the first area (100) of the motion sensor may be consistently changed. When a level is set according to the number of times of sensing an external object, parking recording based on motion sensing is performed (S207). For example, if a previously high-traffic area becomes less active over time, the detection range may be gradually expanded again. The parking recording may be initiated when the external object is sensed within the first area (100) or when the external object is predicted to enter into the first area (100) from the second area (200) within a set time. This predictive function may enhance the system's ability to capture relevant motion events before they reach the immediate detection zone.

The present disclosure suggests a parking motion sensing technology that allows for a vehicle video recording system to operate for a long time with limited power for parking recording, and a radar, a lidar, and the like may be applied as a sensor for sensing motion.

An example of the present disclosure provides a vehicle video recording method that varies a sensing range of a motion sensor based on position information of a vehicle and/or a number of times of sensing movement of an external object in the sensing range, and, in a case where it is determined that movement of the external object has been sensed in the sensing range by the motion sensor, transmits a command to a camera to start recording and enables operation with low power for a long time.

Technical tasks that the present disclosure is to achieve are not limited to the technical tasks described above, and other technical tasks that have not been described will be clearly understood by those having ordinary knowledge in the technical field to which the present disclosure belongs, from the description below.

A vehicle video recording device according to an example of the present disclosure includes a motion sensor configured to sense movement of an external object, a camera configured to record a video outside of the vehicle, and a controller comprising a computer-readable recording medium storing computer-readable instructions and one or more processors configured to execute the computer-readable instructions, wherein the computer-readable instructions, when executed by the one or more processors, cause the controller to adjust one or more settings for a first area of the motion sensor based on position information of the vehicle and/or a number of times of sensing movement of the external object in the first area, and determine that movement of the external object has been sensed in the first area based on information from the motion sensor to transmit a command to the camera to start recording the video.

The position information of the vehicle in at least one example of the present disclosure may include navigation information of the vehicle.

The computer-readable instructions, when executed by the one or more processors, may cause the controller to select at least one of a plurality of sensitivity levels based on the position information and/or the number of times of sensing movement of the external object.

The plurality of sensitivity levels may set by at least one parameter of a false sensing parameter associated with a false sensing area, a time parameter associated with a set time, or a sensing distance parameter of the first area.

The computer-readable instructions, when executed by the one or more processors, may cause the controller to adjust the one or more settings for the first area periodically based on the number of times of sensing an external object.

The computer-readable instructions, when executed by the one or more processors, may cause the controller to determine that sensing performance of the motion sensor is degraded based on a surrounding environment of the vehicle to adjust the one or more settings to extend the first area.

In at least one example of the present disclosure, the computer-readable instructions, when executed by the one or more processors, may cause the controller to determine that an external object is predicted to enter into the first area from a second area within a set time to transmit a command to the camera to start recording the video.

In at least one example of the present disclosure, the fist area may be set such that a false sensing prevention area of the motion sensor is excluded.

Meanwhile, a method of recording a vehicle video according to an example of the present disclosure may include starting, by a controller, a parking mode of the video recording device, sensing, by a motion sensor, movement of an external object in a surrounding of the vehicle, and adjusting one or more settings for a first area of the motion sensor based on position information of the vehicle and/or a number of times of sensing movement of the external object in the first area, and, determining that movement of the external object has been sensed within the first area based on information from the motion sensor to transmit a command to a camera to starting recording a video outside of the vehicle.

In a method of at least one example of the present disclosure, the starting the parking mode may comprise turning the motion sensor ON and switching the camera and the controller into a sleep mode or OFF.

In a method of at least one example of the present disclosure, the position information of the vehicle may include navigation information of the vehicle.

In a method of at least one example of the present disclosure, the adjusting the one or more settings may include selecting at least one of a plurality of sensitivity levels based on position information and/or a number of times of sensing movement of the external object.

In a method of at least one example of the present disclosure, the plurality of sensitivity levels may be set by at least one parameter of a false sensing parameter associated with a false sensing area, a time parameter associated with a set time, or a sensing distance parameter of the first area.

In a method of at least one example of the present disclosure, the adjusting the one or more settings may include adjusting the one or more settings for the first area periodically based on the number of times of sensing an external object.

In a method of at least one example of the present disclosure, the adjusting the one or more settings may include determining that sensing performance of the motion sensor is degraded based on a surrounding environment of the vehicle to adjust the one or more settings to extend the first area.

In at least one example of the present disclosure, the method may further comprise determining, by the controller, that the external object is predicted to enter into the first area from a second area within a set time.

In a method of at least one example of the present disclosure, the first area may be set such that a false sensing prevention area of the motion sensor is excluded.

According to at least one example of the present disclosure, since a motion sensor sensing range varies based on the position information of the vehicle and/or the number of times of sensing an external object, it is possible to significantly reduce a case of a camera and a controller being woke in a situation where there is no danger of accident, and since it is possible to start recording only in a case where it is determined that movement of the external object has been sensed within the varied sensing range, it is possible to increase a parking recording function operation time and to effectively manage a storage memory.

According to an example of the present disclosure, it is possible to realize thereof only by changing a software for the existing video recording device without an additional hardware.

It is obvious for those skilled in the art that the present disclosure may be specified in other specific forms without departing from the gist or essential features of the present disclosure. Therefore, the above-mentioned detailed description should be considered not to be limited but exemplary. The scope of the present disclosure should be determined by reasonable interpretation of the attached claims, and all modifications within the equivalent range of the present disclosure are included in the scope of the present disclosure.

The method according to the above-described examples may be produced as a program that is to be implemented in a computer, the present program may be stored in a computer-readable recording medium, and examples of the computer-readable recording medium include ROM, RAM, CD-ROM, a magnetic tape, a floppy disk, an optical data storage device, and the like.

The computer-readable recording medium may be distributed in a computer system connected via a network, and a computer-readable code may be stored and implemented by a distribution method. In addition, function programs, codes, and code segments to realize the above-described method may be easily inferred by programmers in the technical field under which the examples fall.

It is obvious for those skilled in the art that the present disclosure may be specified in other specific forms without departing from the gist or essential features of the present disclosure.

Therefore, the above-mentioned detailed description should be considered not to be limited but exemplary. The scope of the present disclosure should be determined by reasonable interpretation of the attached claims, and all modifications within the equivalent range of the present disclosure are included in the scope of the present disclosure.

What is claimed:

1. An apparatus comprising:
a processor; and
a memory storing at least one instruction that, when executed by the processor communicating with the memory, is configured to cause the apparatus to:
detect, using a motion sensor, a movement of an external object in a first detection zone monitored by the motion sensor;
based on the detection of the movement, record, using a camera, a video of a surrounding area of a vehicle, wherein the surrounding area comprises at least a portion of the first detection zone; and
adjust one or more settings, of the motion sensor, for the first detection zone based on at least one of position information of the vehicle or frequency of detecting the movement of the external object in the first detection zone, and
transmit, based on the adjusted one or more settings, a command to the camera to adjust recording behavior.

2. The apparatus according to claim 1, wherein the position information of the vehicle comprises navigation information of the vehicle.

3. The apparatus according to claim 1, wherein the at least one instruction, when executed by the processor communicating with the memory, is configured to cause the apparatus to select one of a plurality of sensitivity levels based on at least one of the position information or the frequency of detecting the movement of the external object in the first detection zone.

4. The apparatus according to claim 3, wherein the plurality of sensitivity levels are set by at least one of:
a false sensing parameter associated with a false sensing area,
a time parameter associated with a set time, or
a sensing distance parameter of the first detection zone.

5. The apparatus according to claim 1, wherein the at least one instruction, when executed by the processor communicating with the memory, is configured to cause the apparatus to adjust the one or more settings periodically based on the frequency of detecting the movement of the external object in the first detection zone.

6. The apparatus according to claim 1, wherein the at least one instruction, when executed by the processor communicating with the memory, is configured to cause the apparatus to:
determine that sensing performance of the motion sensor is degraded based on a surrounding environment of the vehicle, and
adjust, based on the determination, the one or more settings to extend the first detection zone.

7. The apparatus according to claim 1, wherein the at least one instruction, when executed by the processor communicating with the memory, is configured to cause the apparatus to:
determine that an external object is predicted to enter into the first detection zone from a second zone within a set time, and
transmit, based on the determination, a command to the camera to adjust the recording behavior by causing at least one of an adjustment of the first detection zone or an adjustment of a recording time associated with the first detection zone.

8. The apparatus according to claim 7, wherein the one or more settings are adjusted to exclude a false sensing prevention area of the motion sensor.

9. A method performed by an apparatus of a vehicle, the method comprising:
starting a parking mode of a video recorder;
detecting, using a motion sensor, a movement of an external object in a surrounding area of the vehicle, wherein the surrounding area comprises at least a portion of a first detection zone monitored by the motion sensor;
adjusting one or more settings, of the motion sensor, for the first detection zone based on at least one of position information of the vehicle or frequency of detecting a movement of the external object in the first detection zone; and
transmitting, based on the adjusted one or more settings, a command to the video recorder to adjust recording behavior for recording the surrounding area of the vehicle.

10. The method according to claim 9, wherein the starting the parking mode comprises:
turning the motion sensor on;
switching the video recorder into a sleep mode or a turned-off state; and
switching a control circuit of the apparatus into a sleep mode or a turned-off state.

11. The method according to claim 9, wherein the position information of the vehicle comprises navigation information of the vehicle.

12. The method according to claim 9, wherein the adjusting the one or more settings comprises selecting one of a plurality of sensitivity levels based on at least one of the position information or the frequency of detecting the movement of the external object in the first detection zone.

13. The method according to claim 12, wherein the plurality of sensitivity levels are set by at least one of:
a false sensing parameter associated with a false sensing area,
a time parameter associated with a set time, or
a sensing distance parameter of the first detection zone.

14. The method according to claim 9, wherein the adjusting the one or more settings comprises adjusting the one or more settings periodically based on the frequency of detecting the movement of the external object in the first detection zone.

15. The method according to claim 9, wherein the adjusting the one or more settings comprises:
determining that sensing performance of the motion sensor is degraded based on a surrounding environment of the vehicle; and
adjusting, based on the determining, the one or more settings to extend the first detection zone.

16. The method according to claim 9, further comprising:
determining that the external object is predicted to enter into the first detection zone from a second zone within a set time.

17. The method according to claim 14, wherein the one or more settings are adjusted to exclude a false sensing prevention area of the motion sensor.

18. An apparatus of a vehicle, the apparatus comprising:
a processor; and
a memory storing at least one instruction that, when executed by the processor communicating with the memory, is configured to cause the apparatus to:
detect, using a motion sensor, at least one detected characteristic of a surrounding area of the vehicle;
adjust, based on the at least one detected characteristic, a setting of the motion sensor, wherein the adjusted setting is associated with at least one of an adjusted detection zone of the motion sensor or an adjusted recording condition of the motion sensor;
control, based on the adjusted setting, the motion sensor to detect motions within at least a portion of the surrounding area of the vehicle; and
perform, based on the detected motions, video recording of the at least the portion of the surrounding area of the vehicle.

19. The apparatus according to claim 18, wherein the at least one detected characteristic of the surrounding area of the vehicle comprises at least one of:
at least one physical object detected in the surrounding area of the vehicle;
a location of the vehicle determined based on navigation information of the vehicle; or
frequency of detecting movement of an external object in the at least the portion of the surrounding area of the vehicle.

20. The apparatus according to claim 18, wherein the setting of the motion sensor is adjusted by modifying at least one of a sensing range, a sensitivity level, or a false sensing prevention parameter of the motion sensor, and wherein the sensing range comprises the at least the portion of the surrounding area of the vehicle.
